(19) United States
(12) Patent Application Publication
(10) Pub. No.: US 2012/0033892 A1
(43) Pub. Date: Feb. 9, 2012

(54) Systems and Methods for Identifying Matching Images of Digital Documents

(75) Inventors: Kevin Paul Blenkhorn, Annapolis, MD (US); Raymond Todd Schenk, Roswell, GA (US); Ari Blenkhorn, Annapolis, MD (US)

(73) Assignee: COREGUARD, Roswell, GA (US)

(21) Appl. No.: 13/197,872

(22) Filed: Aug. 4, 2011

Related U.S. Application Data
(60) Provisional application No. 61/370,662, filed on Aug. 4, 2010.

(51) Int. Cl. G06K 9/68; G06K 9/62

(52) U.S. Cl. 382/218

(57) ABSTRACT

A user interface and interactive application for redacting digital documents are disclosed. This technology allows an operator to perform document recognition and redaction on a small number of representative files and receive feedback on the accuracy of these processes before committing to potentially long and processor-intensive redaction of a larger collection of files. This methodology saves both processor time and operator time for redacting documents, and achieves accurate redaction of a complete set of documents more rapidly than with other commonly-used methods.

### CROSS REFERENCE TO RELATED APPLICATIONS

The benefit of the filing date of U.S. Provisional Patent Application Ser. No. 61/370,662, filed Aug. 4, 2010, entitled “Methodology for Redacting Digital Documents,” is hereby claimed, and the specification thereof is incorporated herein in its entirety by this reference.

### TECHNICAL FIELD

This invention relates in general to application software, and more particularly to software, systems, and methods for identifying matching images of digital documents and acting in a desired way for the same.

### BACKGROUND

Many businesses and government organizations have large collections of paper or digital documents containing clients' personal or sensitive information. Banking and financial institutions, for example, have account application forms that include names, birthdates, social security numbers, and home addresses. Wholesale and retail businesses often save credit card data from every credit sale they make. Government offices have forms that by law must be made public, but which contain some privacy information that must be protected. These institutions are responsible for safeguarding personal information on these forms from misuse. Storing this information poses a legal risk to the company, and safeguarding the information may require additional manpower and security costs.

Many companies find that they do not actually need to keep all of the information they have on file, only certain items. Retail businesses, for example, may generate a form for each purchase that includes the customer's name, address, credit card number, and the product purchased. Once the financial transaction has been completed, they no longer need to store the customer's credit card number, but may wish to keep the rest of the purchase information for their records. However, the retail business cannot easily eliminate the unneeded information, so they retain all data for the entire transaction.

Many companies have shifted to digital records to manage their business. Paper documents such as purchase orders and credit card applications are scanned and stored as digital files. While digital storage can reduce the physical volume of material stored, it does not necessarily simplify protecting that data. In fact, it may make the data more vulnerable. If a business stores client information digitally, a thief can access the digital storage device remotely, or steal all of the information on an easily-concealed CD or removable memory device. Neither of these vulnerabilities holds for cartons or filing cabinets full of paper records.

Businesses try to reduce their liability for protecting personal or other sensitive information by minimizing the amount of this information that they retain. Once files are scanned, the business may decide to redact sensitive information that they do not wish to store long-term. Several software applications exist to perform redaction on digital scans. Their common flaws are that they are generally processor-intensive and do not provide adequate feedback to help the user achieve desired results or improve efficiency. The general methodology for using these software applications is that a human operator marks the area on a single file that is to be redacted, and the redaction software performs the same redaction on large number of similar files. The operator or another user (a quality assurance checker) then inspects the output files to assess how well the redaction software performed. In a worst-case scenario, they may find that the software took several days to run, and had a higher than allowable number of false-negatives or false-positives. A false-negative occurs when it is determined that a template image and a test image do not match each other, when in fact, the information in the template image and the information in the test image do match. A false-positive occurs when it is determined that a template image and a test image match each other, when in fact, the information in the template image and the information in the test image do not match. Both false-negative determinations and false-positive determinations are to be avoided. Because the redaction speed and error rate are not determined until late in the process, a significant amount of processor time and manpower may be used inefficiently or wasted. Additionally, a high error rate for redaction means that the privacy information is not adequately redacted from the files, and is still at risk of theft. A second pass may be just as costly and as ineffective as the first.

While automatic redaction of digital information is a valuable tool for balancing the need to store business data versus the need to protect privacy information, better tools are needed to increase the speed and effectiveness of digital document redaction.

### SUMMARY

Various embodiments of systems and methods for identifying matching images are disclosed. An embodiment is a method for comparing information from digital images. The method comprises the steps of receiving, from a graphical-user interface, a set of pixels in a template image, receiving, from the graphical-user interface, a corresponding set of pixels from a test image, using a processor to compare the set of pixels in the template image to the corresponding set of pixels from the test image and to generate a score responsive to whether the set of pixels in the template image match the corresponding pixels in the test image and publishing the score.

An alternative embodiment is a method for batch processing forms. The method comprises verifying the accuracy of an image matching process that compares a select portion of a template image with a corresponding portion of one or more test images determined to match the template image, verifying the accuracy of the image matching process using one or more test images determined to match the template image and one or more test images determined not to match the template image and having verified the accuracy of the image matching process to accurately identify one or more test images determined to match the template image and the accuracy of the image matching process to accurately identify one or more test images determined to both match and not match the the template image, initiating a batch process that takes an action in response to a determination that an image under test matches the template image.

Another embodiment is a system for processing digital images. The system comprises a processing unit, a memory element and a display. The memory element and the display are coupled to the processing unit. The memory element includes an operator interface and a comparator. The operator interface is embodied as executable instructions that when executed by the processing unit present a template image and a test image. The operator interface provides a first input mechanism that receives an operator input that defines a select portion of the template image that uniquely identifies the template image and a second input mechanism that receives a target value. The comparator is embodied as executable instructions that when executed by the processing unit receive pixel information associated with the select portion of the template image and pixel information from a corresponding portion of the test image. The comparator generates a score responsive to a comparison of the pixel information associated with the select portion of the template image and pixel information from the corresponding portion of the test image. The score is indicative of the probability that the template image and the test image are a match.

### BRIEF DESCRIPTION OF THE DRAWINGS

These and other objects, features, elements and advantages of the systems and methods for comparing and redacting information from digital documents will be more readily apparent from the following detailed description of the illustrated embodiments, in which:

FIG. 1 schematically illustrates an embodiment of a graphical-user interface for configuring the system of FIG. 11;

FIG. 2 schematically illustrates an embodiment of a portion of the graphical-user interface of FIG. 1;

FIG. 3 schematically illustrates an embodiment of the graphical-user interface of FIG. 1 when the system of FIG. 11 is in a manual test mode of operation;

FIG. 4 schematically illustrates an embodiment of the graphical-user interface of FIG. 1 when the system of FIG. 11 is in a batch test mode of operation;

FIG. 5 schematically illustrates an embodiment of the graphical-user interface of FIG. 1 when the system of FIG. 11 is in a batch process mode of operation;

FIG. 6 schematically illustrates an embodiment of the graphical-user interface of FIG. 1 when the system of FIG. 11 provides form-matching test results for multiple modes of operation;

FIG. 7 includes an embodiment of a flow diagram illustrating a workflow and interaction between the batch test mode and manual test mode of operation before entering the batch process mode of operation;

FIG. 8 includes an embodiment of a flow diagram illustrating the manual test mode of operation;

FIG. 9 includes an embodiment of a flow diagram illustrating the batch test mode of operation;

FIG. 10 includes an embodiment of a flow diagram illustrating the batch process mode of operation; and

FIG. 11 includes an embodiment of a system for comparing and redacting information from digital documents.

### DETAILED DESCRIPTION

The above issues are problematic to any organization, business, or government entity that wants to protect sensitive information by redacting it from digital files. The above issues are overcome in an illustrative embodiment of the invention in which a software application provides the operator with an improved method for identifying instances of image files that match a template image. A select portion of image information from the template is used to uniquely identify the template. The operator uses a graphical-user interface to identify the select portion of the template. The image information along a margin of the template will generally provide enough image information to uniquely identify the template. In the example embodiment, an operator of the software application selects the first three characters closest to the left-hand margin of the printed information to uniquely identify a sample form. An operator of the software application is asked to provide a list of one or more images that are known to include a match for the sample form. The operator is then asked to provide sets of images that are both known to be matches for the sample form and known not be a match for the sample form. In a batch test mode, the software application provides visual feedback indicating to the operator that the software application can accurately identify both forms that match the sample form and accurately identify images of documents that do not match the sample form.

Once the operator is satisfied that the software can accurately identify images that match the select portion of the template and identify both images that match the select portion of the template and images that do not match the select portion of the template, the operator can configure the software application to analyze a directory of image files and direct the software application to take a first desired action on image files that are determined to match the sample form and/or a second desired action on image files that are determined not to match the sample form. For example, the software application can be configured to identify matches and move image files that match to a desired directory.

The software application further enables an operator to identify one or more select portions of a test image for modification. For example, when it is determined that the test image is a match for the template, the software application can be configured to replace the image information in one or more operator identified portions of the test image. The one or more operator identified portions of the test image may or may not overlap the image information in the test image that corresponds to the select portion of the template. The operator identified portions of the test image will generally overlap those portions of the test image that include information that is to be redacted from image. In the example embodiment, a social security number and a phone number are redacted from a test image that matches the sample form. Preferably, the modification or redaction of test image information includes the replacement of pixel information from the test image in those pixel locations corresponding to the operator identified portions of the test image with all zeros, although alternating patterns of ones and zeros, random replacement of ones and zeros, and the replacement of pixel information with all ones are believed to be effective to remove the original image information from the test image. In some embodiments, the modification or redaction of the image information in the redaction rectangle is accomplished by replacing the pixel information with information that defines a color.

An image file processing system and method for identifying matching images of digital documents can be implemented in hardware, software, or a combination of hardware and software. When the image file processing system and method for identifying matching images of digital documents is implemented in software, the software can be used to test and confirm desired operation using a limited number of test images and later automatically process image files absent operator intervention. The software can be stored in a memory and executed by a suitable instruction execution system (microprocessor). A hardware implementation of the image file processing system and method for identifying matching images of digital documents can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

The software for the image file processing system and method for identifying matching images of digital documents comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

The term “file” in this patent relates to any digital computer file.

The term “document” refers to a piece of paper, such as a completed credit-card application. In general, this patent discusses “documents” that have been scanned to create digital “files”.

The term “scan” refers to a file that was created by scanning a document. More specifically, it refers to the image itself that was created.

The term “page” refers to a single image in a scan. Scans may comprise one page (“single-page”) or many pages (“multi-page”) depending on the configuration of the originating paper documents. Many documents comprise multiple pieces of paper, and many scanning formats allow more than one page in a single file. For the purposes of running form-matching algorithms and performing redaction, each page of a multi-page file may be treated as a separate file.

The term “form” in this patent relates to the visual arrangement of text, graphics, and other markings on the document page without regard to individual client information. The term may be used to refer to a unique specific form or to a family of similar forms. For example, the Federal Tax Return Form 1040 for tax year 2009 is a “form.” If 1040 forms from two different tax years have only minor visual differences, they could potentially be considered the same form for redaction purposes. If they are significantly different, then they should be treated as separate forms. The collection of files presented for redaction might contain several scans of the same form, each one filled out with a different client's personal information and stored as a separate file. The redaction software considers a number of files and determines which ones match a particular form.

In the preferred embodiment, the files to be redacted are put into a pre-determined hierarchical directory structure. In other embodiments, the files may be spread across a number of directories or different file servers, and a manifest of files and locations is used to collect them for processing.

One directory may contain files which are scans or images of more than one form. The redaction process allows the operator to match files to forms, automatically determining which of several candidate forms a given file is scanned from. The operator can match, redact, and process one form at a time, ignoring non-matching files. The operator opens a representative file in the software application's graphical-user interface (GUI). The operator marks one or more select portions of the image. Preferably, the select portions are defined by rectangular areas. However, other shapes are possible and may be used under circumstances where the design of the form dictates. The redaction software will use these select portions or regions to identify other files that include instances of the same form. These are designated as “identification regions” or “identification rectangles.” The operator optionally marks one or more additional portions of the test image that the redaction software will remove when it finds matching forms. These additional portions are designated “redaction regions” or “redaction rectangles.” If no redaction rectangles are specified, then the software automatically uses the identification rectangles as redaction rectangles.

The preferred embodiment includes several controls for configuring or tuning the software that determines whether a particular file (i.e., image) matches a particular template image (e.g., form 1040 for 2010). These include Dilate, Jitter, Despeckle, Value, Match Type, and Action.

In one aspect of the invention, a “Dilate” control increases or decreases the thickness of lines based on its setting prior to running a matching algorithm. The optimal setting depends on the type and quality of the scanned forms. Changing the line thickness can help to increase the chance of a match for a given form, or for a given set of scanned files.

In one aspect of the invention, a “Jitter” setting determines how far the identification rectangles may be moved or scaled during form matching. The identification rectangles are moved or scaled to allow for scans that are offset or whose size was changed during the scanning process. Offsets and scaling frequently occur when documents are copied, faxed, or run through a scanner. The jitter setting increases the chance of matching a file to a form. Its optimal setting is based on the qualities of a set of scanned files.

In one aspect of the invention, a “Despeckle” control removes small speckles from a scan. Many files include small spots generated during the scanning or faxing process. These spots are artifacts that were not on the original document, and which do not belong on the form. The despeckling process removes these marks. A despeckle value indicates how large an artifact could be considered an unwanted artifact. The operator may indicate whether despeckling is to be applied or whether despeckling is not to be applied. When despeckling is to be applied, the operator can enter a value to determine the maximum size artifacts to remove from the image information.

In one aspect of the invention, a “Value” setting controls the interpretation of the output of the matching algorithm. Redaction software generally uses a software algorithm to determine whether a file matches a particular form. The matching algorithm outputs a numerical value indicating the strength of the match. The “Value” setting allows the allows the operator to select a target value. The choice of a target value varies based on the visual characteristics of the form, the quality of the scans, and the presence of similar forms in the search directories. The operator adjusts the target value based on known positive and negative comparisons to find the optimal value for matching each form.

In one aspect of the invention, a “Match Type” indicates what output value from the form-matching algorithm of the comparator qualifies as a “match” for a particular file. In the preferred embodiment, these can be set to “Match if Greater than Value” or “Match if Less than Value”. In other embodiments, they can also include “Match if Greater than or equal to Value”, “Match if Less than or equal to Value”, and “Match if equal to Value”. A match of “Greater than Value” generally indicates that a particular file is from the same document as a particular form. A match of “Less than Value” generally indicates that a particular file is not the same document as particular form. The “Match Type” value is used in association with an operator configured action.

In one aspect of the invention, an “Action” setting indicates what the software should do with a particular file based on the results as configured by the various operator selected settings and the output of the comparator's form-matching algorithm. In the preferred embodiment, the action settings include “Redact” and “Ignore.” The action settings allow the operator to search for either “positive matches” or “negative matches.” In the preferred embodiment, a positive match occurs when a file is positively identified as the same as a particular form. In the software, this occurs when the “Match Type” setting is set to “Match if Greater than Value” and the value of the form-matching test is greater than the number indicated in the “Value” (i.e., the target value) setting. In other embodiments, this may also occur with “Match Type” set to “Match if Greater than or Equal to Value” and the value of the form-matching test is greater than the number indicated in the “Value” setting. In the preferred embodiment, a negative match occurs when a file is identified as not being the same as a particular form. In the software, this occurs when the “Match Type” setting is set to “Match if Less than Value” and the value of the form-matching test is less than the number indicated in the “Value” setting. In other embodiments, this may also occur with “Match Type” set to “Match if Less than or Equal to Value” and the value of the form-matching test is less than or equal to the number indicated in the “Value” setting. The action indicated in the “Action” setting is taken for either a positive or negative match.

The “Redact” action causes the file to be redacted. The act of redaction includes drawing a rectangle or other obscuring shape over operator configured redaction rectangles in the file. The act of redaction may include redacting the file in place, moving the file to an output directory, or copying the file to an output directory. If a file manifest is used in lieu of a directory structure, the manifest entry may be marked to indicate that the file has been processed and does not require further processing.

The “Ignore” action indicates that the file should not be redacted, but should be moved, copied, or otherwise marked as processed. The ignore action is generally used for identifying files that do not require redaction. For example, a multi-page document may include an instruction page that does not include personal information, but which was scanned along with the rest of the document. The operator may use the ignore feature to identify the files or pages that include instructions or other information that need not be considered or redacted. The files or pages so identified may be deleted entirely, moved to a designated directory, merged with modified or redacted files or otherwise processed.

In one aspect of the invention, a “Test Active” button causes the form-matching algorithm of the comparator to test the match value between two input files. This control directs the comparator to execute the matching algorithm for only one of the identification rectangles. The operator may specify the select identification rectangle by selecting it, or the software may default to using the last identification rectangle created. This function allows the operator to test the effectiveness of a single identification rectangle at a time.

In one aspect of the invention, a “Test Cascade” button causes the form-matching algorithm of the comparator to test the match value between two input files. This control directs the software to execute the matching algorithm for each of the matching rectangles in order. The cascade of tests stops whenever the test for a single rectangle fails. For example, if the “Match Type” is “Greater Than” and the matching value of the first rectangle is greater than the required “Value” entry as determined by the operator, then the cascade continues to match the second rectangle. If the matching value is equal or lower, then the cascade stops running, and the files are reported as not matching.

The image processing system and method for identifying matching images of digital documents includes three levels of feedback on the redaction process. The goals of the testing and feedback are to optimize the percentage of correct form recognition, minimize the percentage of incorrect form recognition, and let the operator know the expected success rate before the operator starts a potentially long and processor-intensive series of image comparisons and results directed actions or file processes. The first level is designated as the “manual test” or manual test mode. During the manual test, the operator selects files to test and observes the results. In the preferred embodiment, the operator selects files using an arrow or “next” button that automatically loads the next file into a GUI. The operator activates the test, and the comparator executes the matching algorithm and determines whether the file is a match based on the above-described settings. The GUI shows the location of the matching rectangles on the image being tested, and the redaction rectangles, if appropriate.

The second level of feedback is designated as the “batch test” or batch test mode. “Batch processing” is the execution of a series of jobs on a computer without the need for manual intervention. In this invention, the GUI is capable of initiating and executing a series of tests when operating in batch test mode. The tests are essentially the same as for the manual test above, but they are run on a collection of files. In the preferred embodiment, the operator may specify to run the test over files located in a particular directory, and may also specify a maximum number of files to use for the testing. The operator may also specify separate “positive” and “negative” directories. The system places image files that are identified as a positive match for the template image (or current form under test) in the positive directory. The system places image files that are identified as not matching the template image in the negative directory.

The preferred embodiment includes an output graph that displays the value result of each test since the last input parameters were changed. These include the dilate setting, jitter setting, match rectangles, and source image. The output graph displays the value from the matching algorithm for each tested file. When using positive and negative directories in batch test mode, the interface displays the matches for positive and negative files separately. The preferred embodiment uses different symbols for differentiating the output of the two file types, and renders their graphs on separate horizontal lines. The configuration of the graph provides visual feedback to inform the operator whether the current input parameters cause a quantitative difference in the ability of the matching algorithm to differentiate between files that match the form and files that do not. The configuration also informs the operator of the optimal range of value settings to use for minimizing false detections from the matching algorithm.

The third level of feedback occurs during a “batch process.” The operator uses the

GUI to initiate batch processing (e.g., redaction) of designated files. Once the batch process is begun, the GUI may be closed without affecting the batch process, which continues executing. An auxiliary application monitors the batch process's run and reports on its progress. Specifically, the monitoring application counts the number of files that have been processed and the number of images that have been processed. The monitor reports the percentages of files that have been determined to match the template image and/or the percentage of files that have been determined not to match the template image. The monitor or reporter module estimates the time remaining to process the remaining files, and the completion time and date.

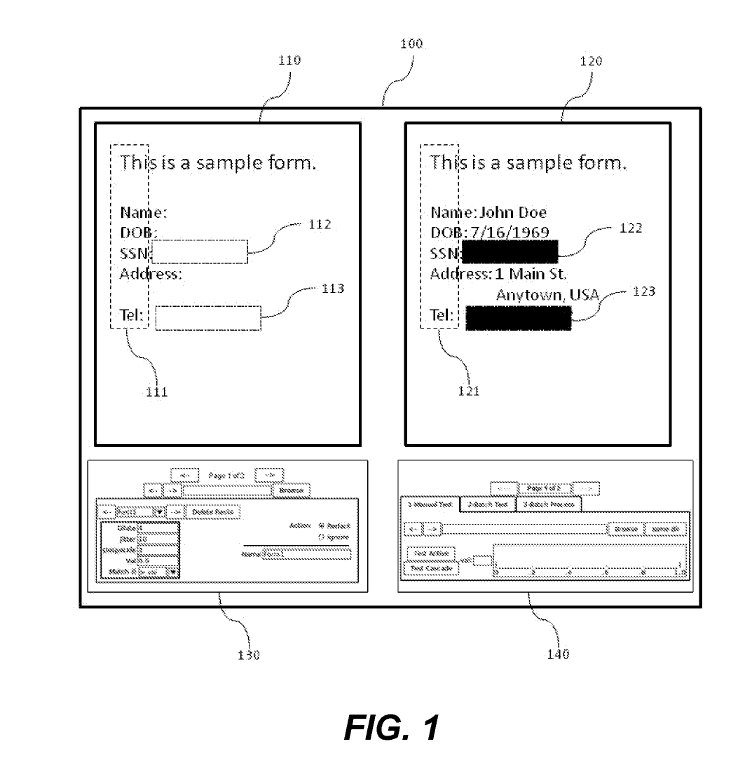

Referring to the drawings, wherein like reference numbers refer to like parts, FIG.1 illustrates one embodiment of a graphical-user interface presented by the system for identifying matching images of digital documents.

FIG.1 shows a representative arrangement of a possible construction of the graphical-user interface 100. The system for identifying matching images of digital documents includes a graphical-user interface 100 (GUI) with multiple panels for operator interaction.

The operator uses the GUI 100 to load an image of a scanned document into a first panel 110. The text in the first panel 110 is a sample of a possible image file that the operator can load. The particular printed information in the first panel 110 is not limited to any specific embodiment. The image information in the first panel 110 is representative of a particular form. This representative image information is hereafter referred to as the “template image.” The operator uses the template image for finding and redacting similar forms.

The operator may load a similar image file created from the same form into a second panel 120. As shown in FIG. 1, the second panel 120 includes an image of a completed or filled version of the sample form. The particular printed information in the second panel 120 is not limited to the illustrated example. The image information or file in the second panel 120 is representative of the same form as the template file shown in the first panel 110. The representative image in the second panel 120 is hereafter referred to as the “test image,” since its purpose is to allow the matching-algorithm of the comparator to test whether a corresponding portion of the test image matches the select portion of the template image.

The operator uses controls within the panel 130 to select or otherwise define one or more identification rectangles 111 on the template image information in the first panel 110. The matching algorithm of the comparator uses the portion of the template image inside these identification rectangles 111 to identify corresponding areas 121 in the test image as shown in the second panel 120. When a match is found between the two image files, by comparing the image information in the identification rectangle 111 of the template image with the corresponding pixel information of the corresponding area 121 of the test image, the system for identifying matching images may be further configured to take one or more actions on the test image information. For example, a redactor may be configured to modify or replace pixel information from one or more operator identified portions of the test image information. Such operator identified portions of the test image include the redaction rectangle 122 and redaction rectangle 123. In the illustrated embodiment, the modified or redacted portions of the test image are illustrated in a solid black color. This is indicative of the replacement of the corresponding pixel information by all zero digital values. Thus, a saved version of the modified or redacted image cannot be reverse engineered to determine the image information that was present in the original test image. Alternatively, the system could replace the pixel information corresponding to redaction rectangle 122 and/or the pixel information corresponding to redaction rectangle 123 with alternating patterns of zeros and ones, or all ones.

In the preferred embodiment, the operator creates identification rectangles 111 on the template image 110 using the left mouse button (LMB). The operator may create multiple identification rectangles 111 by holding down a shift key while also using the LMB. The operator may delete all current identification rectangles 111 by creating a single new identification rectangle 111 without holding down the shift key. If the size of the identification rectangle 111 has width or height equal to zero, then no identification rectangle 111 is created.

In the illustrated embodiment, a single identification rectangle 111 is selected and encompasses rendered information along the left-side margin of the sample form to uniquely identify the template image. In other embodiments a single identification rectangle 111 could be selected along another margin of the sample form or across portions of the sample form that do not change as the form is completed or used. For instances where extraneous marks (e.g., notes, check marks, etc.) have been added in a relatively consistent location across the test images, an operator of the GUI 100 may elect to select a single identification rectangle 111 along one of these alternative margins or even across a mid-portion of the template image to avoid unintended mismatches in a batch test or batch process. In still other alternative embodiments, more than one identification rectangle 111 may be selected for uniquely identifying the template image. Although the illustrated single identification rectangle 111 encompasses the entirety of the printed or rendered information along the left-side margin, the identification rectangle 111 is not so limited and in other embodiments may exclude some but not all information. That is, the identification rectangle 111 can be selected over a mid-portion of the sample form. Using the sample form as a guide, an alternative identification rectangle 111 may rectangle 111 may encompass the left-most portion of form field labels Name, DOB, SSN, and Address, while excluding the left-most portion of the form title and the form field label for the telephone number.

The redaction rectangle 122 and the redaction rectangle 123 on the test image are arranged in the proper location and orientation on the test image in order to redact the portion of the template image 110 requested by the operator with the redaction rectangle 112 and the redaction rectangle 113. The placement of the redaction rectangle 122 and the redaction rectangle 123 on the test image 120 are based on the relationship between the identification rectangle 111 of the template image and the corresponding rectangle 121 of the test image. The corresponding rectangle 121 of the test image is where the matching algorithm found the portion of the image described in the identification rectangle 111 from the template image 110. The corresponding rectangle 121 may be offset, scaled, and rotated from the identification rectangle 111. This system for identifying and matching images of digital documents calculates any offset, scaling, and rotation between the identification rectangle 111 and the image information in the corresponding rectangle 121 and determines the origin for the transformation. The system then applies the same transformation to the redaction rectangle 112 and the redaction rectangle 113 from the template image 110 and uses the results of this calculation to determine the proper position, scaling, and rotation for the respective redaction rectangle 122 and redaction rectangle 123 in the test image.

In the preferred embodiment, the operator creates redaction rectangle 112 and redaction rectangle 113 on the template image 110 using the right mouse button (RMB). The operator may create multiple redaction rectangles 112, 113 by holding down a shift key while also using the RMB. The operator may delete all current redaction rectangles 112, 113 by creating a single new redaction rectangle (not shown) without holding down the shift key. If the size of the redaction rectangle 112 or the redaction rectangle 113 has a width or a height equal to zero, the system responds as if no redaction rectangle was identified.

In the event that the operator does not create a redaction rectangle such as the redaction rectangle 112 and the redaction rectangle 113 on the template image 110, the software treats the identification rectangle 111 as a redaction rectangle for the purposes of identifying the image information that is to be modified and/or replaced from the test image.

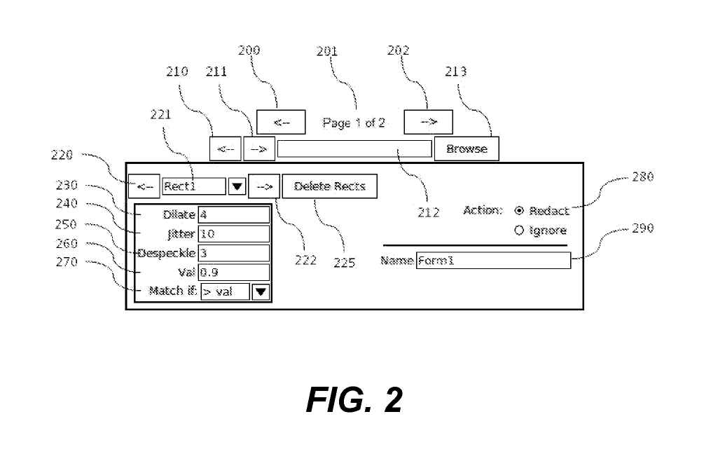

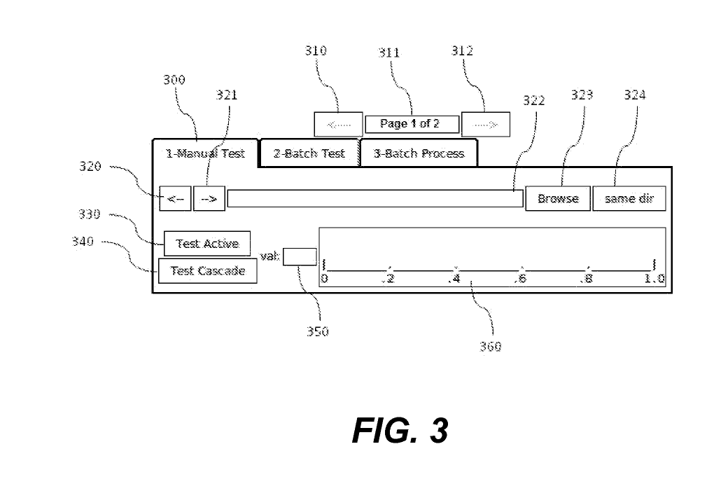

In the preferred embodiment, the operator has a series of controls for loading images and manipulating test parameters. These controls are presented in the panel 130 and the panel 140 of the GUI 100. A detailed description of the controls in panel 130 follows in FIG. 2. A detailed description of the controls in panel 140 follows in FIGS. 3-6.

FIG. 2 shows a representative layout of controls for loading a template image in the panel 110 and for tuning the form-matching algorithm of the comparator.

Representative controls for selecting a template image file are shown in the second row of controls from the top of the interface. The “Browse” button 213 opens a menu for selecting a file. The file name is displayed in the entry field 212 to the left of the browse button 213. The pushbutton with a leftward facing arrow 210 and the pushbutton with a rightward facing arrow 211 allow the operator to easily cycle through multiple template images in the same directory. Selecting pushbutton 210 unloads the current template image and loads the image that immediately precedes it in a directory listing. Selecting pushbutton 211 unloads the current template image and loads the image that immediately follows it in a directory listing.

If a single image file contains multiple pages of images, the operator may select among the pages using the pushbutton 200 and pushbutton 202. The pushbutton 200 switches to a previous page, and the pushbutton 202 switches to a subsequent page. The text 201 between the pushbuttons indicates the current page number of the image in the first panel 110 and the total number of pages (i.e., the number of images) in the file presently displayed in the entry field 212.

The operator may select an “active” identification rectangle 111 in the template image (FIG. 1). In the preferred embodiment, the operator may select the identification rectangle using one of three ways: by selecting the numbered rectangle from a drop down list 221, by cycling through the list of rectangles with pushbutton 220 and pushbutton 222, or by creating a new identification rectangle 111, which defaults to being the active identification rectangle 111. Several of the parameters identified in the configuration fields 230-270 may be associated with a particular identification rectangle 111. The operator may set different configuration parameter values for each identification rectangle 111 or may use the same values for each. Changing the active identification rectangle displayed in the drop down list 221 will change the values of the parameters 230-270 to the current values for the active identification rectangle 111.

The operator may need to delete the current list of identification rectangles. In the preferred embodiment, the operator may do this by either creating a single rectangle to replace the current list, or by using the “Delete Rects” button 225 to delete them.

The operator sets the dilate value 230 with the “Dilate” entry field. In the preferred embodiment, this value is typed directly into the corresponding entry field. In other embodiments, the dilate value 230 may be controlled by a menu, drop down list, slide bar, or other graphical control.

The operator sets the jitter value 240 with the “Jitter” entry field. In the preferred embodiment, this value is typed directly into the corresponding entry field. In other embodiments, the jitter value 240 may be controlled by a menu, drop down list, slide bar, or other graphical control.

The operator sets the despeckle value 250 with the “Despeckle” entry field. In the preferred embodiment, this value is typed directly into the corresponding entry field. In other embodiments, the despeckle value 250 may be controlled by a menu, drop down list, slide bar, or other graphical control.

The operator sets a target or minimum value 260 or score required to indicate a match between the select portion of the template and the corresponding image information in the test form. In the preferred embodiment, this value is typed directly into the corresponding entry field. In other embodiments, the target value 260 may be controlled by a menu, drop down list, slide bar, or other graphical control.

The operator may set the match-type value 270 with the “Match If” drop down list. In the preferred embodiment, the legal values are selectable with a drop down list. In other embodiments, the match-type value 270 may be controlled by a menu, checkbox, or other graphical control.

The operator selects an action for the system for identifying matching images of digital documents to take when the matching conditions are satisfied by selecting an item from the “Action” menu 280. In the preferred embodiment, the operator may select only one of the listed items and the menu defaults to the “Redact” action. In the illustrated embodiment, the operator is presented with alternative options of redact and ignore. In alternative embodiments (not shown) the GUI 100 can be configured to present additional actions including multiple actions performed in a desired sequence.

The operator enters a name for the form in the “Name” entry field 290. This is the name that the system will use to store the form information for later use, such as if the operator wishes to process more files in the future using the same source template, parameters, and action(s).

FIG. 3 shows a representative layout of controls presented in the panel 140 (FIG. 1) when the system is in the manual test mode of operation. The operator selects the manual test mode by selecting the left-most tab from the set of tab controls 300.

Representative controls for selecting a test image are shown in the controls across the top of the figure. The “Browse” pushbutton 323 opens a menu for selecting a file. The file name is displayed in the entry field 322 to the left of the Browse pushbutton 323. Pushbutton 320 and pushbutton 321 allow the operator to easily cycle through multiple images in the same directory. Selecting the pushbutton 320 unloads the current test image and loads the image that immediately precedes the current test image in a directory listing. Selecting the pushbutton 321 unloads the current test image and loads the image that immediately follows the current test image in a directory listing. Selecting the pushbutton 324 sets the directory for test images to the same directory as that defined for the template image. If a single image file contains multiple pages of images, the operator selects among the pages using the pushbutton 310 and the pushbutton 312. The pushbutton 310 switches the image in the second panel 120 (FIG. 1) to a previous page, and the pushbutton 312 switches the image in the second panel 120 to a subsequent page. The text 311 between the buttons indicates the current page number and the total page numbers for the identified image file.

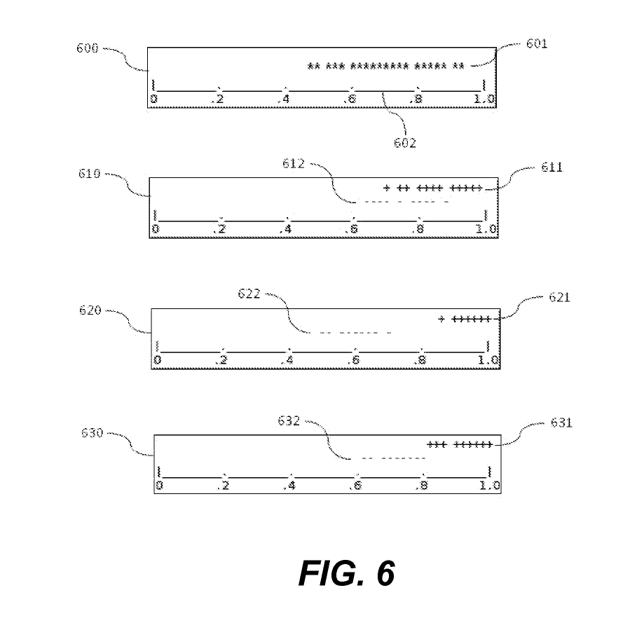

The “Test Active” pushbutton 330 directs the system to execute the form-matching algorithm of the comparator on the template image and the test image presented in the first panel 110 and the second panel 120, respectively. As indicated above, the comparison is performed over the pixel information in the active identification rectangle shown in the drop down list 221, as indicated in panel 130. The resulting output value from the form-matching algorithm is displayed in the “val” entry 350. This value is also displayed visually in the graph 360. Details of the graph portion of this screen are described in association with FIG. 6.

The “Test Cascade” pushbutton 340 directs the system to execute the form-matching algorithm of the comparator on the template image and the test image presented in the first panel 110 and the second panel 120, respectively using all of the identification rectangles 111. The form-matching algorithm generates a separate output value for each identification rectangle 111. If one of the respective comparisons of the image information fails to identify a match, then the cascade test is stopped. An operator of the image processing system uses the GUI 100 to adjust the location of the one or more identification rectangles 111 and/or to adjust one or more of the dilate value 230, jitter value 240 and despeckle value 250 in an iterative process until selection of the pushbutton 240 results in an identified match between the template image and the test image. The image. The final resulting output value from the form-matching algorithm is displayed in the “val” entry 350. This value is also displayed visually in the graph 360.

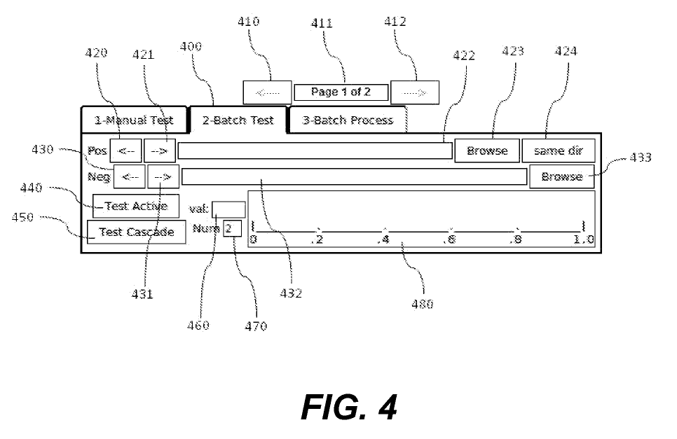

FIG. 4 shows a representative layout of controls presented in the panel 140 (FIG. 1) when the system is in the batch test mode of operation. The operator selects the batch test mode with the middle tab from the set of tab controls 400.

Representative controls for selecting test images are shown in the controls illustrated across the top row of the figure. The top row of controls labeled “Pos” is for marking a directory of image files that are known to be derived from the same form as the template image. The “Browse” pushbutton 423 opens a menu for selecting a directory. The current file name in the directory is displayed in the entry field 422. The pushbutton 420 and pushbutton 421 allow the operator to easily cycle through multiple images in the select directory. Selecting the pushbutton 420 unloads the current test image from the panel 120 and loads the image that immediately precedes the current test image in a directory listing. Selecting the pushbutton 421 unloads the current test image from the second panel 120 and loads the image that immediately follows the current test image in a directory listing. The “same dir” button 424 sets the directory for the positive images to be the same directory as the template image.

The row of controls labeled “Neg” is for marking a directory of image files that are known to not be derived from the same form as the template image. The “Browse” pushbutton 433 opens a menu for selecting a directory. The current file name in the directory is displayed in the entry field 432. The pushbutton 430 and the pushbutton 431 allow the operator to easily cycle through multiple images in the same directory. Selecting the pushbutton 430 unloads the current test image in the second panel 120 and loads the image that immediately precedes the current test image in a directory listing. Selecting the pushbutton 431 unloads the current template image in the second panel 120 and loads the image that immediately follows the current test image in a directory listing.

If a single image file contains multiple pages of images, the operator selects among the pages using pushbuttons 410 and pushbutton 412. The pushbutton 410 switches the image in the second panel 120 to a previous page and the pushbutton 412 switches the image in the second panel 120 to a later page. The text 411 between the buttons indicates the current page number and the total number of pages in the identified image file.

The “Test Active” pushbutton 440 and the “Test Cascade” pushbutton 450 direct the system to perform in a similar fashion as in the manual test mode described above. The difference when in the batch test mode of operation, is that the active or cascade tests may be each run on multiple test images rather than a single image. The “Num” entry 470 indicates the number of total form-matching tests to run each time the “Test Active” pushbutton 440 or the “Test Cascade” pushbutton 450 is selected. The batch test process starts by performing a comparison of the image information between the select portion of the current template image in the first panel 110 and the corresponding image information in the current file indicated in the field 422. The current test image is loaded into the second panel 120. Once the form-matching test is complete, the output value or score is placed into the “val” entry 460 and displayed on the graph 480. The next file to be tested is the current file in the negative directory 432. The output value of this test is similarly entered into the “val” entry 460 and displayed on the graph 480. The system alternates between select or images under test from the positive directory 422 and the negative directory 432 until the system has tested the maximum number of files required as indicated in entry 470 or has run out of files in the respective directories. If one directory is not indicated or does not have any files in it, then it is not used.

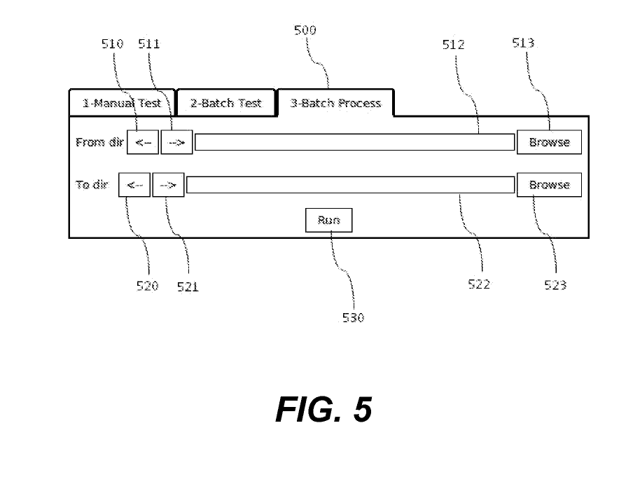

FIG. 5 shows a representative layout of controls presented in the panel 140 when the system is operated in the batch process mode. The operator selects this mode of operation by selecting the right-most tab from the set of tab controls 500.

Representative controls for selecting a directory of source files are shown in the controls across the top of the figure. The “Browse” button 513 opens a menu for selecting a directory. The current directory name is displayed in the entry field 512. The pushbutton 510 and the pushbutton 511 enable the operator to easily cycle through multiple directory names. Selecting the pushbutton 510 unloads the present directory and selects the name of the previous directory in a list of source directories and presents this directory in the entry field 512. Selecting the pushbutton 511 unloads the present source directory and selects a subsequent source directory in a list of source directories and outputs the selected source directory in the entry field 512.

Representative controls for selecting a destination directory for processed files are shown in the controls in the lower row of the interface. The “Browse” button 523 opens a menu for selecting a directory. The current directory name is displayed in the entry field 522. The pushbutton 520 and the pushbutton 521 enable the operator to easily cycle through multiple directory names. Selecting the pushbutton 520 selects the name of the previous destination directory in a list of destination directories and outputs this destination directory in the entry field 522. Selecting the pushbutton 521 unloads the present destination directory and selects the name of the next destination directory in a list of destination directories and presents the select destination directory in the entry field 522.

Operator selection of the “Run” pushbutton 530 directs the system to initiate a batch or automated process. Consequently, the system proceeds to process all of the files in the source directory according to the parameters set by the operator absent operator intervention. The system may modify or entirely redact, copy or move files from the source directory to the destination directory if the match conditions set by the operator in the panel 130 are met. In the preferred embodiment, the choice of copying or moving may be set by the operator in a command-line parameter. In other embodiments, the system may choose whether to copy or move a test image based on a configuration file or a graphical operator control.

FIG. 6 shows a representative layout of the output graph. This graph provides feedback on the form-matching test results for multiple operator modes. Each version of the graph includes a bar 602 that shows a scale for the comparison score. In this embodiment, the scale from 0.0 to 1.0 represents the normalized range of output scores from the form-matching algorithm of the comparator. In other embodiments, an output graph may show the actual matching value, or some other representative value.

The graph 600 is representative of output from the manual test mode. A control interface for configuring the manual test mode was described in association with FIG. 3. The symbols 601 in the graph 600 indicate values achieved for various tests. In this embodiment, each output from the form-matching test is indicated on the graph 600 as an asterisk. Multiple results with the same or similar values show up as a single asterisk. For example, if three tests resulted in a value of 0.6, the collection of results would show up as a single asterisk above the 0.6 mark on the bar 602. In another embodiment, multiple results of the same value are stacked on top of each other. In a third embodiment, a number is substituted for the asterisk to indicate the number of matches. In another embodiment, color is used to indicate the number of matches. In other embodiments, the symbol may be something other than an asterisk.

Graph 610, graph 620 and graph 630 are representative of output scores from a batch process mode. A control interface for configuring the batch test mode was described in association in FIG. 4. The score information 611, score information 621, and score information 631 indicate form-matching output values from the positive files that are chosen with the controls 420-424 (FIG. 4). In the preferred embodiment, these matches are indicated with a plus sign “+.” In other embodiments, output scores from comparisons between a template image and documents that are known to match the template image can be marked with alternative symbols. As with the symbols 601 described above, the score information 611, score information 621 and score information 631, can be presented in a stacked arrangement, using color fonts, etc.

The score information 612, score information 622, and score information 632 indicate form-matching output values from the negative files that are chosen with the controls 430-433 (FIG. 4). In the preferred embodiment, these matches are indicated with a minus sign “−.” In other embodiments, output scores from comparisons between the template image and documents that known not to match the template image can be marked with alternative symbols. The score information 612, score information 622 and score information 632, can be presented in a stacked arrangement, using color fonts, etc.

The graph 610, graph 620, and graph 630 show representative examples of graphically represented output scores that are presented to an operator of the system. The operator uses the output scores from the graph 610, graph 620 and or graph 630 to adjust the identification rectangles 111 (FIG. 1) and the form-matching parameters 230-250 (FIG. 2) in order to optimize the form-matching algorithm before initiating a batch process over the contents of a source directory that may contain any number of images to be processed.

The graph 610 indicates to the operator that the identification rectangles 111 and the form-matching parameters 230-250 are not able to unambiguously differentiate between a known positive match and a known negative match with the corresponding image information of the template image. The score information 611 indicative of matches with known matching test images has an output range of approximately 0.70-0.98. The score information 612 indicative of identified known test images that do not match the template image has an output range of approximately 0.64-0.88. The overlap between the two ranges is from 0.70-0.88. If the operator were to use the current identification rectangles 111 and form-matching parameters 230-250, there is no cutoff value 260 that would be less than all of the positive matches and above all of the negative matches. This indicates to the operator that they should continue to adjust these settings to better differentiate between images that are known positive matches and images that are known not to match the template image.

The graph 620 indicates to the operator that the identification rectangles 111 and the form-matching parameters 230-250 are able to unambiguously differentiate between a known positive match and a known negative match with the corresponding image information of the template image. The score information 621 indicative of known test images that match the template image has an output range of approximately 0.85-1.00. The score information 622 indicative of identified test images that do not match the template image has an output range of approximately 0.50-0.70. There is a clear split between the sets of score information 621 and the score information 622. The graph 620 indicates to the operator that a batch process using these parameters would likely have a high success rate, with few false-positive or false-negative results. By observing the split between the two sets of results, the operator can see that a cutoff or target value 260 of between 0.70-0.85 should suffice. That is, such a target score, if used in the batch processing of multiple instances of completed forms, should result in a limited number of false-positives or false-negative results. If the operator wishes to minimize false positives at the expense of false negatives, the operator can choose a number at the upper end of this range. If the operator wishes to minimize false negatives at the expense of false positives, the operator can choose a number at the lower end of this range. By selecting a number in the middle, the operator will minimize false matches of both kinds.

The graph 630 indicates to the operator that the identification rectangles 111 and the form-matching parameters 230-250 are just barely able to differentiate between a known positive match and a known negative match with the corresponding image information of the template image. The score information 631 indicative of known test images that match the template image has an output range of approximately 0.81-1.00. The score information 632 indicative of identified test images that do not match the template image has an output range of approximately 0.62-0.80. The ranges do not overlap, but they are very close. If the operator were to set a cutoff value 260 of 0.81 as the minimum matching value, then the test files would all be properly determined. However, the test files generally represent a small sample of the complete list of files to process, so other files might easily be incorrectly determined with this cutoff value. This information allows the operator to take one of several actions that best serve his goals. The operator may continue to adjust the identification rectangles 111 and the form-matching parameters 230-250 to achieve a graph with a larger split between the positive and negative results, such as the one pictured in graph 620. The operator may set a cutoff value 260 of 0.81 and accept the higher chance of detection errors. Or the operator may adjust the cutoff value 260 up or down to generate primarily false positives or false negatives, respectively.

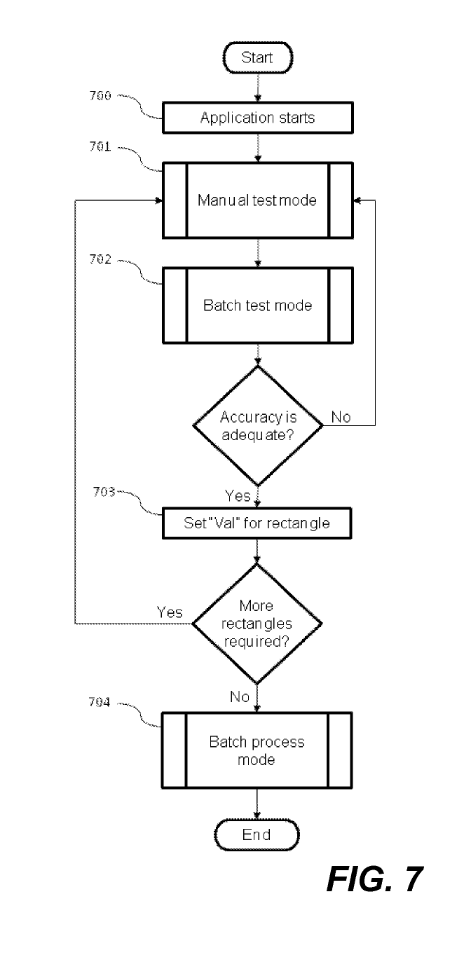

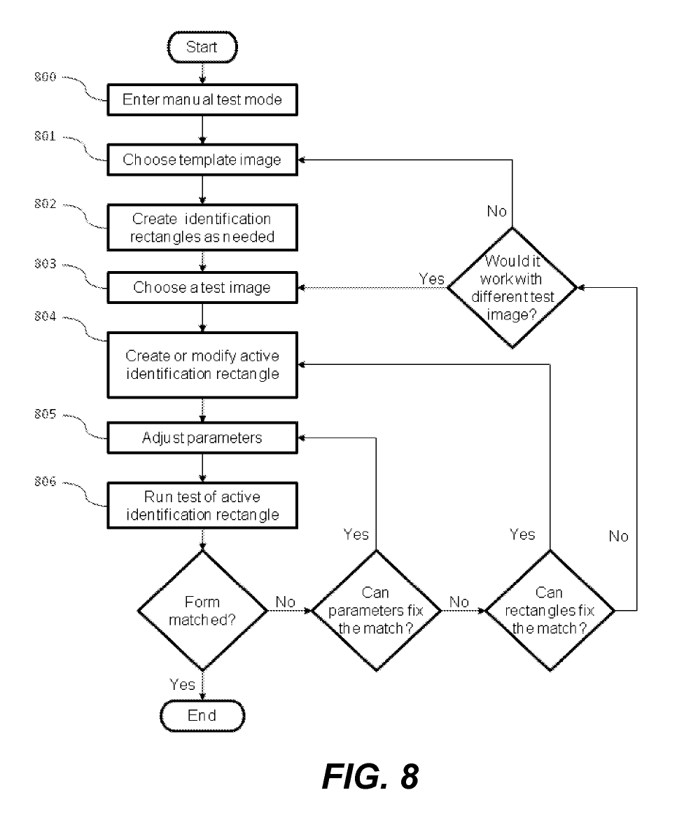

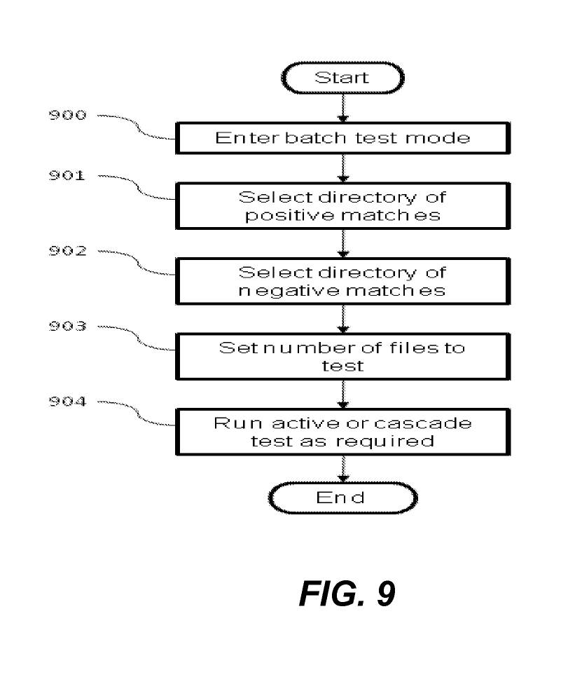

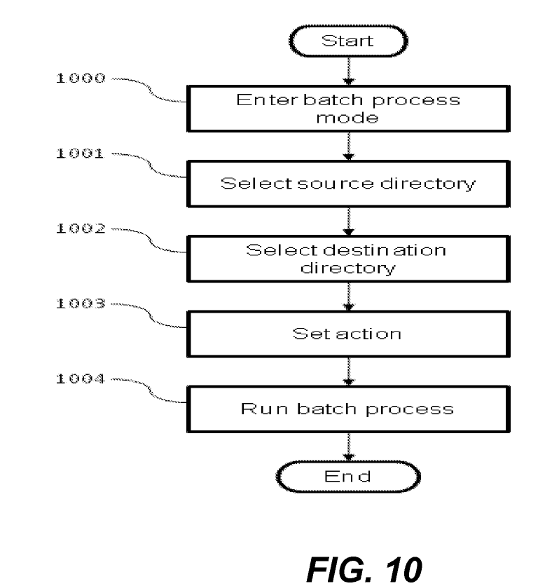

Illustrative operation of the system is described in association with the flow diagrams illustrated in FIGS. 7-10. FIG. 7 depicts high-level workflow and feedback between the three operational modes. The inner workings of the manual test mode are illustrated in FIG. 8. FIG. 9 includes a flow diagram showing operation of the batch test mode. FIG. 10 includes a flow diagram showing operation of the batch process mode.

A system for identifying matching images of digital documents is initialized as indicated in block 700. The system may be operated either locally or remotely via a network.

As indicated in block 701, the operator directs the system to enter a manual test mode. That is, the system receives an input that directs the system to enter the manual test mode. The manual test mode focuses on testing small amounts of data at a time, so that the operator can perform multiple iterations of quick tests to tune the process parameters. The operation of the manual test mode is illustrated and described in association with the flow diagram in FIG. 8.

Thereafter, the system receives an input that directs the system to enter a batch test mode as indicated in block 702. In an embodiment, the batch test mode focuses on testing the optimized identification rectangle and configuration parameters derived in the manual test mode 701 against a larger number of test images. The batch test mode 702 provides feedback to the operator on how well the parameters can be expected to perform against a representative set of sample images. The inner workings of the batch test mode are illustrated and described in association with the flow diagram in FIG. 9.

Once the batch test mode 702 is complete, the operator analyzes the feedback from the batch test mode 702 and decides whether the form-matching accuracy is adequate. The accuracy of form-matching algorithms varies greatly based on the style of form, quality of the images, and the presence of similar forms in the image samples. The need for accuracy also varies with the specific application. It is up to the operator to determine what qualifies as “adequate” for his purposes. This step provides him with tools to help him make that determination. The output from the batch test mode may include the graphs from FIG. 6, which indicate whether the form-matching algorithm is able to unambiguously discriminate between positive (matching) and negative (non-matching) examples of the form. If the operator deems that the form-matching accuracy is not adequate, then the operator reverts to manual test mode 701 to further refine the inputs. That is, the system receives an input directing the system to return to the manual test mode of operation.

If the operator determines that the form-matching accuracy is adequate for the active rectangle, then the operator chooses a cutoff or target value to enter for the active rectangle as indicated in block 703. This value, along with the match type 270 (FIG. 2), are used by the system in making a determination whether a form (i.e., an image under test) matches or not.

If the operator decides that more identification rectangles are needed in order to adequately identify the current form, then the operator enters an input that directs the system to return to the manual test mode 701. In the manual test mode the operator uses the graphical-user interface to identify a new portion of the template image to be tested and adjusted.

If the operator decides that the current set of identification rectangles is adequate for his needs, then the operator enters an input that directs the system to enter a batch process mode as shown in block 704. The batch process mode 704 automatically executes the form-matching algorithm of the comparator and redaction process of the redactor across the image files in a source directory. In the preferred embodiment, the system creates a new executable process to execute these processes, which may be executed locally or on distributed processors. However executed, the application software copies or moves the processed files to a destination directory as directed by configuration information. In other embodiments, the system may execute these processes in the current application, and may modify the files in place, copy them to new filenames, or rename them.

FIG. 8 depicts the workflow of the manual test mode. The manual test mode is the predefined process shown in bock 701 (FIG. 7).

The operator directs the system to enter the manual test mode as shown in block 800. The system may enter this mode of operation in response to an input such as the selection of a tab selected from a set of tabs 300 presented in a panel 140 of a GUI 100. In the preferred embodiment, the manual test mode is used to identify a template file and configure operator selectable configuration controls to direct the comparison of select image information from the template file with corresponding image information from a single test file. The operator uses this manual test mode to receive quick feedback on how well the form-matching algorithm of the comparator is working with its given input parameters.

As indicated in block 801, the operator chooses a template image. This is accomplished via one or more controls provided by the GUI 100. The template image is a representation of a particular form or portion of a form. The template image will later be compared to other images to determine which files are to be processed. This step is optional if a template image has already been loaded. If the system has arrived at this point through the addition of a second identification rectangle, operator input (or the lack of an operator input) may direct the system to continue to use the existing template image.

As shown in block 802, the operator uses the GUI 100 to create redaction rectangles (as needed) on the template image. The redaction rectangles describe the portion of the template image that is to be redacted from a test image upon the identification, by the system, of a successful match between the template image and the test image. The operator may skip this step if redaction rectangles are not required (e.g., when forms are desired to be sorted into specified directories).

As indicated in block 803, the operator uses the GUI 100 to choose a test image 803. 803. The test image is generally representative of the same form as that in the template image. The operator may alternatively use the GUI 100 to choose a test image that is not representative of the same form as the template image. Doing so allows him to test whether the form-matching algorithm of the comparator will be able to identify and disregard non-matching images. This step is optional if a template image has already been loaded. If the system has arrived at this point through the addition of a second identification rectangle, operator input (or the lack of an operator input) may direct the system to continue to use the existing template image.

The operator uses the GUI 100 to communicate inputs that direct the system to create or modify an active identification rectangle, as shown in block 804. In the preferred embodiment, the operator uses the GUI 100 to create an initial identification rectangle after the template image is loaded. The new identification rectangle defaults to being active. If the identification rectangle already exists at this point, the operator may edit it, delete and replace it, or select a different identification rectangle.

As indicated in block 805, the operator uses the GUI 100 to communicate one or more signals that direct the system to adjust the process parameters that are applied to the form-recognition algorithm. In the preferred embodiment, these include Dilate 230, Jitter 240, Despeckle 250, and Match Type 270. In other embodiments, they may include additional or fewer parameters than these.

As shown in block 806, the system tests the active rectangle. This test includes the execution of the form-matching algorithm between the image information from the select portion of the template and corresponding image information from the test image using the active rectangle and the above-defined process parameters. This test provides visual feedback on the effectiveness of the form-matching algorithm to find a single matching rectangle between the two images.

If the form-matching algorithm works and is able to find a rectangle on the test image that matches the portion of the template image marked by the identification rectangle, and is also able to place the redaction rectangles properly on the test image, then the feedback loop for editing the current identification rectangle is complete.

If the tuning of the identification rectangle and process parameters is not adequate to provide a proper match, then there are four feedback loops, the execution of which may improve the recognition. The workflow may begin with the innermost feedback loops, so as to minimize the changes to the input or the number of steps required by the operator to direct the editing.

The first loop is the “parameter loop.” The operator determines whether changing the process parameters will likely improve the form-matching ability. If so, the system upon receipt of an operator input, will return to block 805, where the system will present a suitable GUI for the operator to modify one or more of the process parameters. The operator may try several different settings for the process parameters before attempting the second feedback layer.

The second loop is the “identification rectangle loop.” The operator determines whether changing the position, size, or shape of the active identification rectangle will likely improve the form-matching ability. If so, the system, upon receipt of a suitable operator input, will return to block 804, where the system will present a GUI that enables the operator to enter inputs to modify the active identification rectangle. The operator may try several different settings for the active identification rectangle and/or the process parameters before attempting the third feedback loop.

The third loop is the “test image loop.” The operator determines whether changing the current test image will likely improve the form-matching ability. If so, the system, upon receipt of a suitable operator input, will return to block 803, where the system will present a GUI that enables the operator to enter inputs to select a different test image. The operator may choose to leave the identification rectangles and process parameters as they are before conducting the first test, in order to minimize the changes to the test conditions.

The fourth loop is the “template image loop.” The operator uses a GUI to communicate one or more inputs that direct the system to select a different template image, as indicated in block 801. Thereafter, the system and recommences the manual test process.

FIG. 9 depicts the workflow of the batch test mode. The batch test mode is the predefined process shown in block 702 (FIG. 7).

The operator uses a GUI to communicate one or more inputs that direct the system to enter the batch test mode, as indicated in block 900. The operator may enter this mode via pushbutton 400. In the preferred embodiment, this mode is optimal for testing the template file against several test files at a time, which may include files that are known to match the template image and files that are known to not match the template file. The operator uses this mode for quick feedback on how well the form-matching algorithm can be expected to perform against a large number of unknown files.

As shown in block 901, the operator uses a GUI to communicate one or more inputs that direct the system to select a directory of positive matches, i.e., image files that are known to match the template image. This directory contains image files that have been visually or otherwise identified as being a positive match for the template image (e.g., a form).

As indicated in block 902, the operator uses a GUI to communicate one or more inputs that direct the system to select a directory of negative matches, i.e., image files that are known not to match the template image. This directory contains image files that have been visually or otherwise identified as not matching the template image. The purpose of this portion of the test is to differentiate between the resulting values for positive and negative matches. The operator may choose not to use known mismatches for the batch test if desired.

Next, as shown in block 903, the operator uses a GUI to communicate one or more inputs that set the number of files to test. In the preferred embodiment, the operator does this by entering the number of test files to be used in the “Num” entry 470 (FIG. 4).

Thereafter, as illustrated in block 904, the operator directs the system to execute a form-matching algorithm between the template image and each of the designated test images. The operator may direct the system to test with either a single active rectangle or other portion of the template image or may use an entire cascade of available rectangles or portions of the template. The system provides visually observable information regarding the ability of the form-matching algorithm to generate results or scores that identify or otherwise confirm known matches between the template image and the one or more test images known to match the template image, as well as the ability of the form-matching algorithm to generate results that identify or confirm known mismatches between the template image and the one or more test images that are known to not match the template image. The visually observable information presented to the operator is dependent upon the operator configurable logic for processing the various comparisons and the image information in those portions of the test images that correspond to the one or more active rectangles.

FIG. 10 depicts the workflow of the batch process mode. The batch process mode is the predefined process shown in block 704 (FIG. 7).

As shown in block 1000, the operator uses a GUI to communicate one or more inputs that direct the system to enter the batch process mode. The operator may enter this mode via the selection of pushbutton 500 (FIG. 5). In the preferred embodiment, this mode is optimal for executing the form-matching algorithm against the list of source files and processing them based on the operator requirements.

As illustrated in block 1001, the operator uses a GUI to communicate one or more inputs that direct the system to select a directory of source files. In the preferred embodiment, the directory includes all the image files of a particular type that the operator desires to be processed. In other embodiments, it may point to a list, database, or other or other data structure of filenames that are to be processed.

As indicated in block 1002, the operator uses a GUI to communicate one or more inputs that direct the system to select a destination directory. In the preferred embodiment, the destination directory defines a directory where files will be moved, copied, or saved after the image files in the source directory have been processed. In other embodiments, the destination directory may point to a naming convention, list, database, or other data structure that indicates a destination for output files.

In block 1003, the operator uses a GUI to communicate one or more inputs that direct the system to select the action to be taken for the current form. The operator may enter this in the “Action” widget 280 (FIG. 2). In the preferred embodiment, the action indicates what the system will do with any file that has a positive match with the template image. In other embodiments, the action to be taken may also indicate an action to be taken for files that fail, or for files that pass or fail within a specified percentage of the cutoff or target value. This would allow, for example, files that match strongly to be handled differently than files that match weakly.

Thereafter, as indicated in block 1004, the operator uses a GUI to communicate one or more inputs that direct the system to execute the batch process. The operator may initiate execution of the batch process by selecting the “Run” pushbutton 530 (FIG. 5).

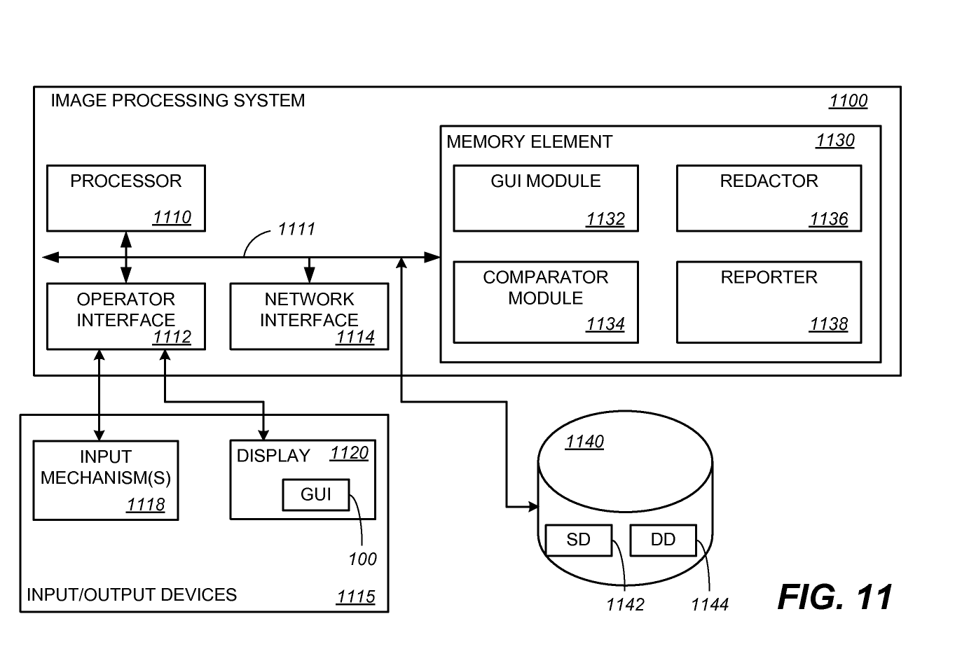

FIG. 11 includes an embodiment of a system for comparing and redacting information from digital documents. The system 1100 includes a processing unit or processor 1110, a display or monitor 1120, and a memory element 1130. The memory element 1130 includes a first module or program 1132 that enables an operator interface, and a second module or comparator 1134 that identifies matches and mismatches between image information from a select portion of a template image and a corresponding portion of a test image. The first module or program 1132 includes executable instructions that when executed by the processing unit 1110 direct the operator interface to present or otherwise enable operator selectable controls associated with a manual test, a batch test and batch processing modes of operation.

An exemplary embodiment of an image processing system 1100 for identifying matching images of digital documents can be embodied in a computer. The computer essentially can be a personal computer system that has been suitably programmed or otherwise configured, as described below. But for the software elements described below, the computer can have a conventional structure and configuration.

Accordingly, the image processing system 1100 includes hardware and software elements of the types commonly included in such computer systems, such as a processor or processing unit 1110, a memory element 1130, non-volatile data storage 1140 (e.g., a hard disk drive, FLASH memory, etc.), and a network interface 1114. The image processing system 1100 also includes an operator interface 1112 through which data communication with input mechanism(s) 1118 such as a keyboard, mouse or other pointing device, display 1120 and other peripheral devices can occur. The operator interface 1112 can comprise universal serial bus ports or any other suitable type of ports. In other embodiments, the image processing system 1100 can include hardware and software elements in addition to those described herein or that are different from those described herein. The above-described processor 1100, operator interface 1112, network interface 1114 and memory element 1130 can communicate with one another via a digital bus 1111. The image processing system 1100 communicates with remote devices (not shown) via a network connection, such as a connection to the Internet.

Memory element 1130 is generally of a type in which software elements, such as data and programming code, are operated upon by the processor 1110. In accordance with conventional computing principles, the processor 1110 operates in accordance with programming code, such as operating system code and application program code. In the exemplary embodiment of the invention, such application program code can include the following software elements: a first module or GUI support module 1132, a second module or comparator 1134, a third module or redactor 1136, and a fourth module or reporter 1138. Although these software elements are conceptually shown for purposes of illustration as stored or residing in memory element 1130, persons skilled in the art to which the invention relates can appreciate that such software elements may not reside simultaneously or in their entireties in memory element 1130 but rather may be retrieved in portions on an as-needed basis, e.g., in code segments, files, modules, objects, data structures, instruction-by-instruction, or any other suitable basis, from data storage 1140 or other suitable source (e.g., via network interface 1114). For example, a source directory 1142 including one or more test images or images to be compared and a destination directory 1144 are identified in respective locations of a file system stored within data store 1140. Files in the source directory may be read and portions of the image information therein may be acted upon by the comparator 1134 and the redactor 1136 before writing a result and/or a modified version of the files in the destination directory 1144. Note that although only GUI module 1132, comparator module 1134 redactor module 1136 and reporter module 1138 are shown for purposes of clarity, other software elements of the types conventionally included in computers systems that enable them to operate properly are generally included, such as operating system software.

It should be noted that, as programmed or otherwise configured in accordance with the above-described software elements or modules, the combination of the processor 1110, memory element 1130 (or other element or elements in which software is stored or resides) and any related elements, generally defines a programmed processor system. It should also be noted that the combination of software elements and the medium on which they are stored or in which they reside (e.g., memory element 1130, data storage 1140, network coupled data stores, etc.) generally constitutes what is referred to as a “computer program product.”

In the exemplary embodiment, a computer-implemented method of identifying matching images of digital documents can be initiated by an operator who interacts with the image processing system 1100. An operator can interact with the image processing system 1100 locally using the one or more of the input/output devices 1115 including the input mechanism(s) 1118 and the GUI 100, or remotely via network interface 1114. In operation, and in accordance with the effects of executed software elements that can include the GUI module 1132, the image processing system 1100 can provide a suitable environment through which the operator can interact with the image processing system 1100.

The second module or comparator 1134 includes executable instructions that when executed by the processing unit 1110 present a template image and a test image in conjunction with the first module or program 1132. The first module or program 1132 provide a first input mechanism to receive operator input that defines a select portion of the template image that uniquely identifies the template image and a second input mechanism to receive a target value. The second module or comparator 1134 includes executable instructions that when executed by the processing unit 1110 receive pixel information associated with the select portion of the template image and pixel information from a corresponding portion of the test image. The second module or comparator 1134 executes a form-matching algorithm that generates a score responsive to a comparison of the pixel information associated with the select portion of the template image and pixel information from a corresponding portion of the test image. The score is an indicator of the probability that the template image and the test image match.

As further illustrated in FIG. 11, the memory element 1130 further includes a third module or redactor 1136 and a fourth module or reporter 1138. The redactor 1136 includes executable instructions that when executed by the processing unit 1110, are responsive to a non-corresponding portion of the test image received from the operator interface, wherein the redactor 1136 modifies and/or replaces pixel information associated with the non-corresponding portion of the test image. The reporter 1138 includes executable instructions that when executed by the processing unit 1110, generate information that is sent to the operator interface by way of the first module or program 1132. In this regard, the information sent to the operator interface includes information that is responsive to results from a batch process. The results include an estimate (e.g., a date and/or time of when the batch process may be complete. In addition, the results may include a current number of positive matches, negative matches, and total files processed. Furthermore, the results may include an expected number of test images that will be identified as either positive or negative matches based on the results of the prior batch processing. Moreover, the results may include raw data or percentages.

What is claimed is:

1. A method for comparing and redacting information from digital images, the method comprising:
receiving, from a graphical-user interface, a set of pixels in a template image;
receiving, from the graphical-user interface, a corresponding set of pixels from a test image;
using a processor to compare the set of pixels in the template image to the corresponding set of pixels from the test image and to generate a score responsive to whether the set of pixels in the template image match the corresponding pixels in the test image; and
publishing the score.

2. The method of claim 1, further comprising:
receiving a target value;
comparing the score with the target value to generate a result; and
providing, in the graphical-user interface, indicia of the result.

3. The method of claim 2, wherein comparing the score with the target value to generate a result comprises using one of greater than, less than, equal to, greater than or equal to, and less than or equal to.

4. The method of claim 2, wherein comparing the score with the target value to generate a result comprises using a logical operator to create a complex match.

5. The method of claim 2, further comprising:
receiving, from the graphical-user interface, indicia of an action to take responsive to the result.

6. The method of claim 5, wherein the action to take responsive to the result is a file level operation.

7. The method of claim 1, further comprising:
pre-processing the test image before comparing the set of pixels in the template image to corresponding pixels in the test image.

8. The method of claim 7, wherein pre-processing is responsive to an operator selectable parameter received from the graphical-user interface.

9. The method of claim 1, further comprising:
receiving, from the graphical-user interface, a non-corresponding set of pixels from the test image indicative of image information that is desired to be modified from the test image when the test image matches the template image;
modifying the non-corresponding set of pixels to create a modified test image; and
storing, in a memory device, the modified test image.

10. The method of claim 9, wherein modifying the non-corresponding set of pixels to create the modified test image comprises replacing pixel information with the same digital value across the non-corresponding set of pixels.

11. The method of claim 9, wherein modifying the non-corresponding set of pixels to create the modified test image comprises replacing pixel information across the non-corresponding set of pixels such that the original image information is obfuscated from the perspective of an observer of a rendered representation of the modified test image.

12. The method of claim 1, wherein the set of pixels in the template image are operator selected.

13. The method of claim 1, wherein the set of pixels in the template image are arranged proximate to a margin of the template.

14. The method of claim 1, wherein the set of pixels in the template image uniquely define a form.

15. A method for batch processing forms, comprising:
verifying the accuracy of an image matching process that compares a select portion of a template image with a corresponding portion of one or more test images determined to match the template image;
verifying the accuracy of the image matching process using one or more test images determined to match the template image and one or more test images determined not to match the template image; and
having verified the accuracy of the image matching process to accurately identify one or more test images determined to match the template image and the accuracy of the image matching process to accurately identify one or more test images determined to both match and not match the template image, initiating a batch process that takes an action in response to a determination that an image under test matches the template image.

16. The method of claim 15, wherein the select portion of the template image is proximate to a margin and includes rendered information.

17. The method of claim 15, wherein the action includes modifying pixel information in the image under test in response to a second select portion of the template image.

18. A system, comprising:
a processing unit;
a display monitor coupled to the processing unit;
a memory element coupled to the processing unit, the memory element having stored therein:
an operator interface including executable instructions that when executed by the processing unit present a template image and a test image, the operator interface module providing a first input mechanism to receive operator input that defines a select portion of the template image that uniquely identifies the template image and a second input mechanism to receive a target value;
a comparator including executable instructions that when executed by the processing unit receive pixel information associated with the select portion of the template image and pixel information from a corresponding portion of the test image, the comparator generating a score responsive to a comparison of the pixel information associated with the select portion of the template image and pixel information from a corresponding portion of the test image, the score indicative of the probability that the template image and the test image match.

19. The system of claim 18, wherein the memory element has stored therein a redactor including executable instructions that when executed by the processing unit, are responsive to a non-corresponding portion of the test image received from the operator interface, the redactor modifying pixel information associated with the non-corresponding portion of the test image.

20. The system of claim 18, wherein the operator interface comprises a graphical-user interface that presents controls associated with a manual test mode, a batch test mode and a batch processing mode.

21. The system of claim 18, wherein the memory element has stored therein a reporter including executable instructions that when executed by the processing unit, are responsive to results of a batch process.

22. The system of claim 21, wherein the reporter calculates an estimate of batch process completion and communicates the same to the operator interface.

23. The system of claim 21, wherein the reporter determines a current number of positive matches, negative matches, and total files processed and communicates one or more of the same to the operator interface.

24. The system of claim 23, wherein the reporter communicates raw data or percentages.

25. The system of claim 21, wherein the reporter determines an expected number of test images that will be identified as either positive or negative matches based on the results of the prior batch processing.
